(19) United States
(12) Patent Application Publication
(10) Pub. No.: US 2026/0088343 A1
(43) Pub. Date: Mar. 26, 2026

(54) METHOD FOR MANUFACTURING COMPOSITE CERAMIC ELECTROLYTE PARTICLES WITH HYDROPHOBIC PROTECTIVE LAYERS FOR BATTERY ELECTRODE

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 18/896,972

(22) Filed: Sep. 26, 2024

(51) Int. Cl. H01M 10/0562; C01G 25/00; H01M 4/62; H01M 10/42

(52) U.S. Cl. CPC H01M 10/0562; C01G 25/006; H01M 4/62; H01M 4/625; H01M 10/4235; C01P 2006/40; H01M 2300/0071; H01M 2300/0094

(57) ABSTRACT

A method for manufacturing composite ceramic electrolyte particles with hydrophobic protective layers for a battery electrode includes the steps of: placing a plurality of first LLZO particles, a methanol and a plurality of hydrophobic particles into a wet mixer for mixing; then placing a tris material and a tris(hydroxymethyl)aminomethane hydrochloride into the wet mixer for stirring to cause each of the first LLZO particles and the hydrophobic particles is coated with a hydroxide ion layer; and then placing a dopamine hydrochloride into the wet mixer for mixing to cause dopamine molecules of the dopamine hydrochloride are co-polymerized to form a dopamine layer coated on the hydroxide ion layer on the corresponding first LLZO particle or hydrophobic particle, and the first LLZO particles having the dopamine layer are coated with corresponding hydrophobic particles having the dopamine layer to form composite LLZO particles.

### FIELD OF THE INVENTION

The present invention is related to a battery electrode material, and in particular to a method for manufacturing composite ceramic electrolyte particles with hydrophobic protective layers for a battery electrode.

### BACKGROUND OF THE INVENTION

A typical battery is formed by the electrodes (positive and negative) placed in an electrolyte. In the prior art, LLZO (lithium lanthanum zirconium oxide) material is added into the electrodes to increase the ionic conductivity. Because LLZO particles has a high ionic conductivity for lithium ions, when lithium ions pass through the electrode, in particular a negative electrode, the lithium ions can be dispersed by the guiding of the dispersed LLZO particles. Therefore, the lithium ions can be evenly distributed inside the negative electrode, which avoids the abnormal accumulation of lithium ions in the negative electrode slurry to cause a side reaction.

However, moisture exists during the manufacturing process of the electrode, and the LLZO particle is hydrophilic and is easy to be dampened to form an alkali by the reaction with the water, resulting in deterioration of the material in the negative electrode slurry.

### SUMMARY OF THE INVENTION

Accordingly, for improving above mentioned defects in the prior art, the object of the present invention is to provide a method for manufacturing composite ceramic electrolyte particles with hydrophobic protective layers for a battery electrode, wherein multiple mixing stages are used in the present invention to replace the conventional single mixing stage. Therefore, in the present invention, the mixing process is divided into multiple stages to extend the whole reaction time, which can make the LLZO particles have a smaller size and a larger surface area to effectively and fully react with the tris and dopamine hydrochloride. As a result, the surface of the LLZO particle can be completely coated with a solid dopamine layer. The outer surface of the LLZO particle having the dopamine layer is further coated with hydrophobic barium titanate composite particles and hydrophobic zinc oxide composite particles, resulting forming a better hydrophobic protective structure. As a result, the composite LLZO particle of the present invention has an enhanced lithium conductivity and no reaction will be formed between the water and the LLZO particles in the manufacturing process of electrodes, which achieves a better manufacturing quality of the battery electrode material.

To achieve above object, the present invention provides

### BRIEF DESCRIPTION OF THE DRAWINGS

FIG. 1 is a steps flow diagram showing the process of the present invention.

FIG. 2 is a steps flow diagram showing the process of step A of the present invention.

FIG. 3 is a steps flow diagram showing the process of step B of the present invention.

FIG. 4 is a steps flow diagram showing the processes of step C and step D of the present invention.

FIG. 5 shows an application of the present invention.

FIG. 6 is a schematic view showing the full structure and the partial structure of the hydrophobic LLZO particle, wherein the polymerization triggered by dehydration is formed between the OH ion of the dopamine molecule of the dopamine layer and the third OH-ion of the hydroxide ion layer.

FIG. 7 is a schematic view showing the full structure and the partial structure of the hydrophobic barium titanate composite particle.

FIG. 8 is a schematic view showing the full structure and the partial structure of the hydrophobic zinc oxide composite particle.

FIG. 9 is a schematic view showing the partial structure of the outer hydrophobic layer of the present invention.

FIG. 10 is another steps flow diagram showing the process of the present invention.

FIG. 11 is a schematic view showing the structure of the composite LLZO particle of the present invention.

FIG. 12 is a schematic view showing the structure of the carbon-material-coated composite LLZO particle of the present invention.

FIG. 13 is a cross-section view of FIG. 11.

FIG. 14 is another steps flow diagram showing the processes of step C and step D of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

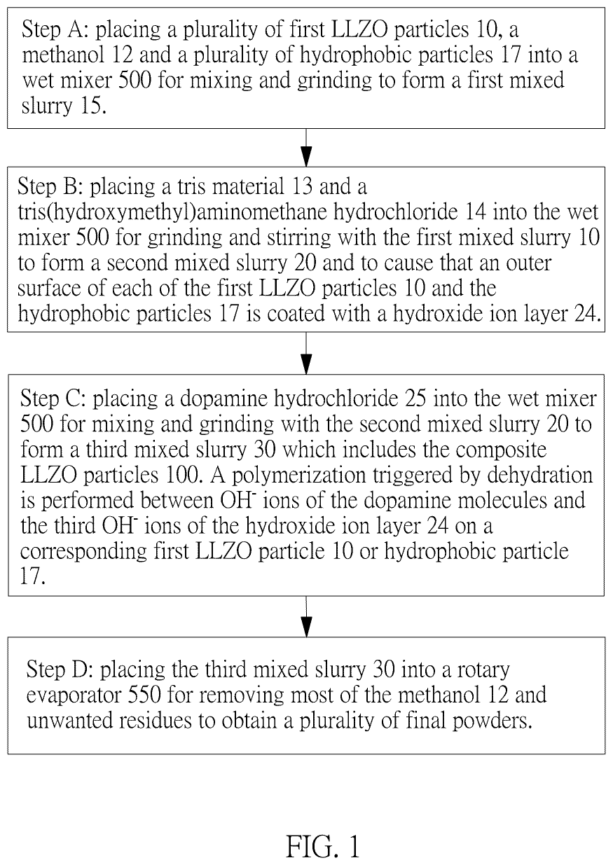

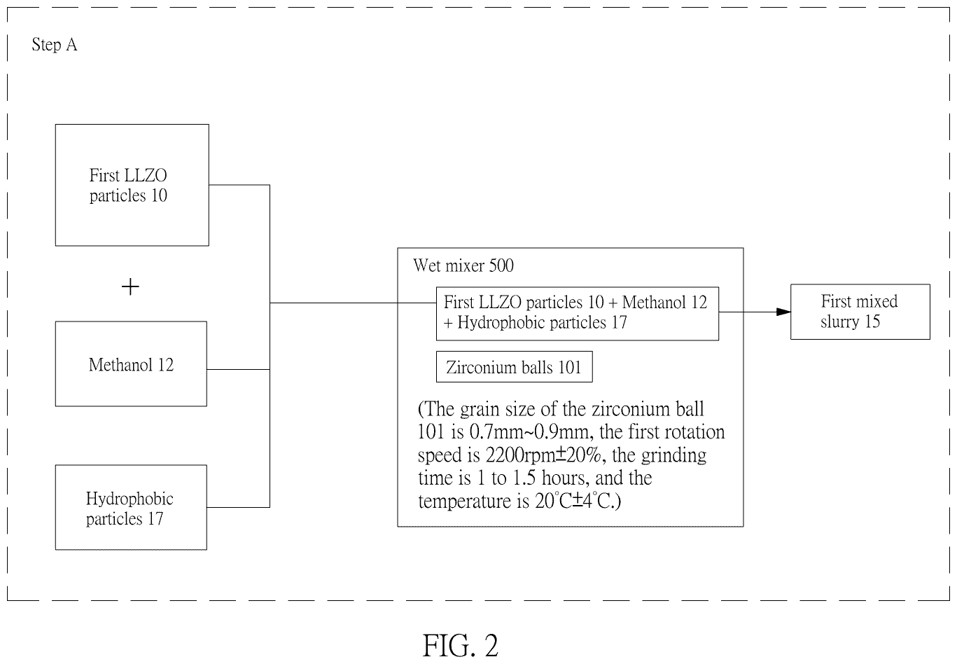

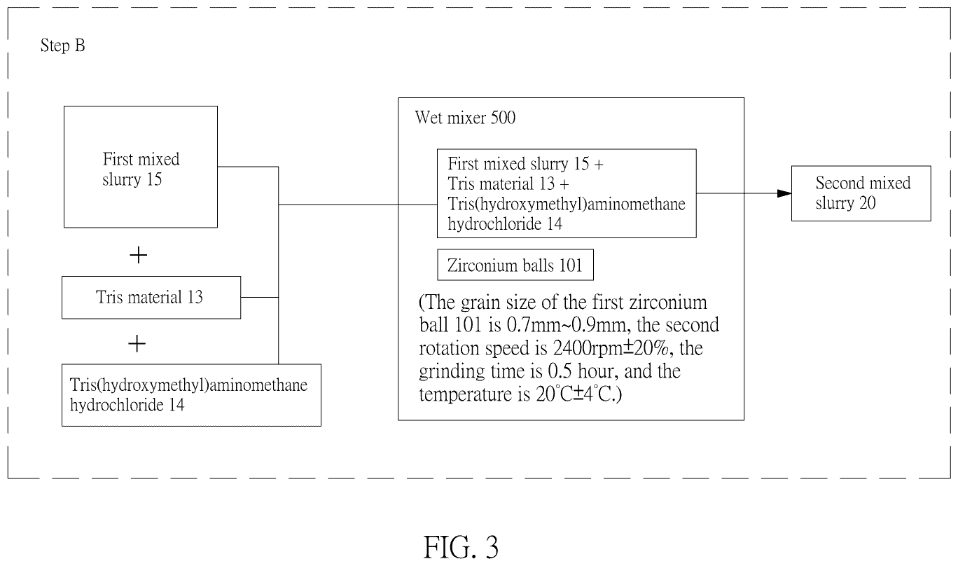

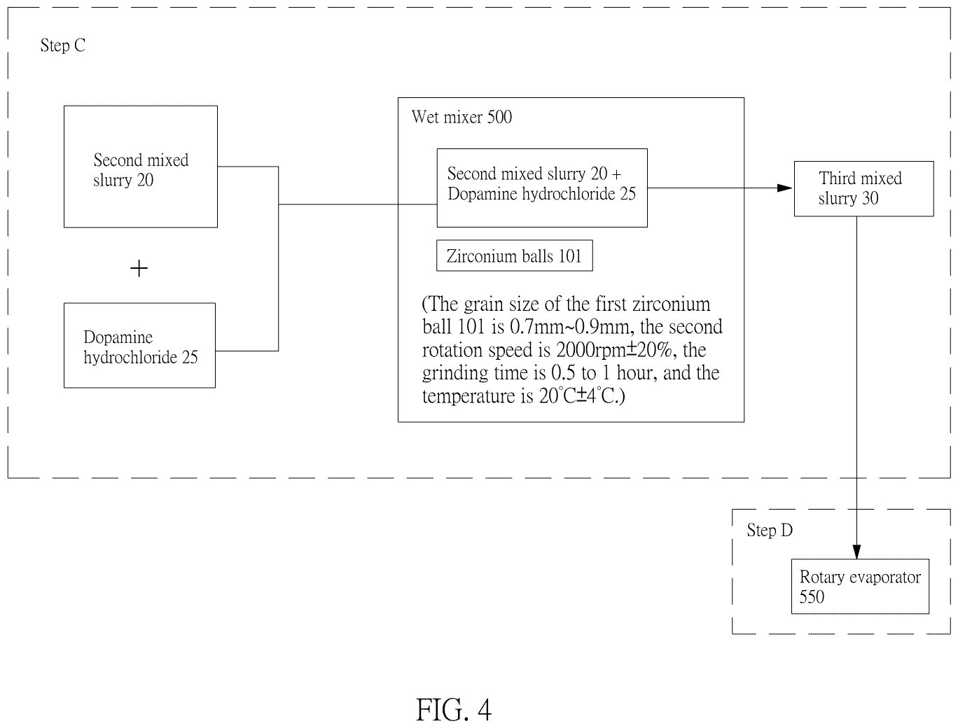

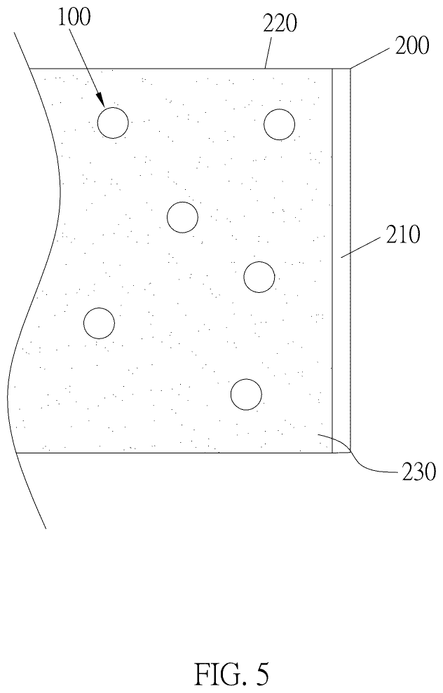

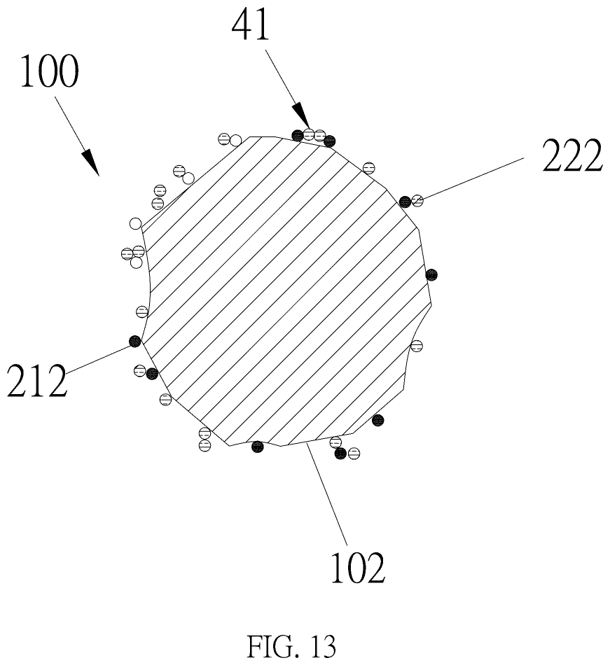

With reference to FIGS. 1 to 14, the present invention provides a method for manufacturing composite ceramic electrolyte particles with hydrophobic protective layers for a battery electrode. The composite ceramic electrolyte particles are a plurality of composite LLZO particles 100. The composite LLZO particle 100 is used in the battery electrode and the battery electrode is an electrode 200 of a solid-state or semi-solid battery. In the application, a plurality of composite LLZO particles 100 can be added into the electrode 200, wherein the electrode 200 is in particular a negative electrode of the solid-state or semi-solid battery. A size of the composite LLZO particle 100 is 50 nm to 200 nm. Referring to FIG. 5, the electrode 200 includes a substrate 210 for carrying the material of the electrode 200, and an electrode slurry layer 220 coated on the substrate 210. The electrode slurry layer 220 includes the composite LLZO particles 100 and an electrode slurry 230 which is used as a binder. The electrode slurry 230 is formed by at least one of styrene-butadiene rubber (SBR), carboxymethyl cellulose (CMC) and auxiliary agent (carbon nanotube or Super-P (conductive carbon black)). A weight percentage of the composite LLZO particles 100 in an electrode slurry layer 220 (in particular a negative electrode slurry layer) is 0.5 wt %˜5 wt %.

Referring to FIGS. 1 to 4, the method of the present invention comprises the following steps of:

Step A: placing a plurality of first LLZO particles 10, a methanol 12 and a plurality of hydrophobic particles 17 into a wet mixer 500 for mixing and grinding at a first rotation speed to form a first mixed slurry 15. The hydrophobic particles 17 are a plurality of barium titanate particles 21, or are a plurality of zinc oxide particles 22, or are the barium titanate particles 21 and the zinc oxide particles 22. Each of the hydrophobic particles 17 is selected from one of the barium titanate particle 21 and the zinc oxide particle 22.

Before the mixing and grinding of the wet mixer 500, a size of each of the first LLZO particles 10 is 2 μm˜10 μm. Each of the first LLZO particles 10 is a cube having an irregular three-dimensional shape. A size of each of the barium titanate particle 21 and the zinc oxide particle 22 is 10 nm˜20 nm. An outer surface of each of the first LLZO particles 10 and the hydrophobic particles 17 has oxidizing functional groups.

Each of the first LLZO particles 10 is formed by LLZO (lithium lanthanum zirconium oxide, Li₇La₃Zr₂O₁₂) or LLZO doped with at least one metal (such as gallium(Ga)-doped LLZO (Li_{6.2}Ga_{0.8}La₃Zr₂O₁₂), aluminum(Al)-doped LLZO or barium(Ba)-doped LLZO.

A ratio of a total weight of the first LLZO particles 10 and a weight of the methanol 12 is 0.8˜1.2:4. A ratio of a total weight of the hydrophobic particles 17 and the total weight of the first LLZO particles 10 is 1/25˜ 1/10 (4%˜10%).

The wet mixer 500 has a plurality of zirconium balls 101 for mixing and grinding to cause that the size of each of the first LLZO particles 10 is smaller than 500 nm after the mixing and grinding. The first rotation speed of the wet mixer 500 is 2200 rpm±20%. Each of the first zirconium balls 101 has a grain size of 0.7 mm to 0.9 mm. A filling ratio of a total volume of the zirconium balls 101 is 70% to 90%, which is a ratio of the total volume of the zirconium balls 101 to a grinding volume of the wet mixer 500. A mixing and grinding time of the wet mixer 500 is 1 to 1.5 hours. An operation temperature of the wet mixer 500 is 20° C.±4° C.

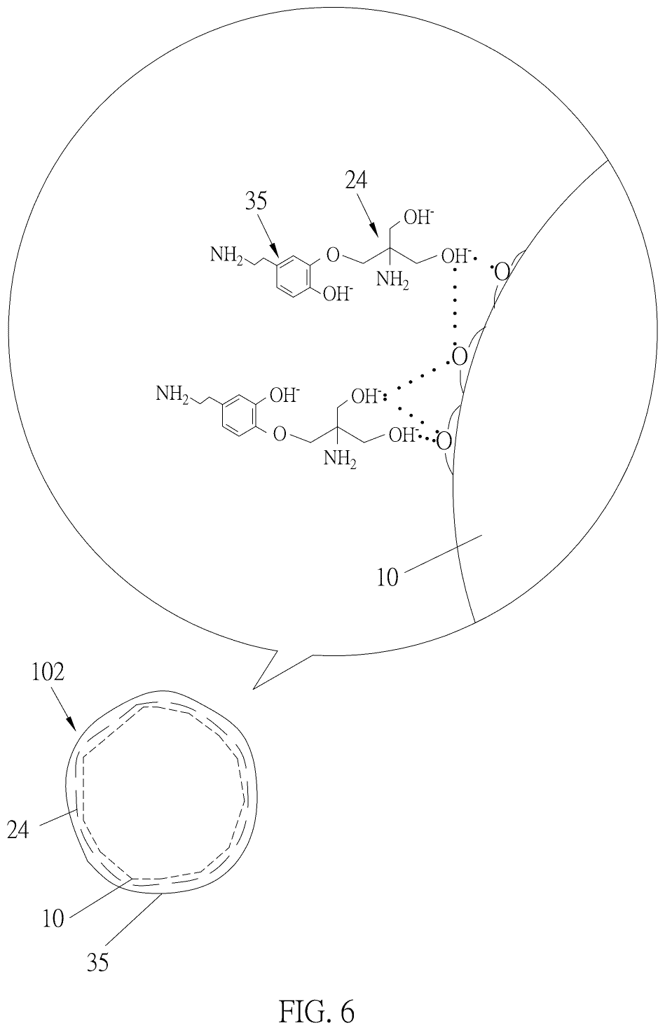

Step B: placing a tris (tris(hydroxymethyl)aminomethane, (HOCH₂)₃CNH₂) material 13 and a tris(hydroxymethyl)aminomethane hydrochloride (NH₂C(CH₂OH)₃·HCl) 14 into the wet mixer 500 for grinding and stirring with the first mixed slurry 10 to form a second mixed slurry 20 and to cause that an outer surface of each of the first LLZO particles 10 and the hydrophobic particles 17 is coated with a hydroxide ion (OH⁻) layer 24. The hydroxide ion layer 24 has a plurality of third OH⁻ ions. Each of tris molecules in the tris material 13 and the tris(hydroxymethyl)aminomethane hydrochloride 14 has three OH⁻ ions which are a first OH⁻ ion, a second OH⁻ ion and the third OH⁻ ion. The first OH⁻ ions and the second OH⁻ ions of the tris molecules are bound to the oxidizing functional groups on a corresponding first LLZO particle 10 or hydrophobic particle 17 by hydrogen bonding. The third OH⁻ ions of the tris molecules extend outward to an outer side of the corresponding first LLZO particle 10 or hydrophobic particle 17 to form the hydroxide ion layer 24 on the corresponding first LLZO particle 10 or hydrophobic particle 17 (the barium titanate particle 21 or zinc oxide particle 22), as shown in FIGS. 6 to 8. A thickness of the hydroxide ion layer 24 is 0.5 nm to 2 nm. FIGS. 6 to 8 show examples of only two tris molecules and are not used to limit the scope of the present invention.

A ratio of a weight of the tris material 13 and a weight of the tris(hydroxymethyl)aminomethane hydrochloride 14 is 8:2.

In the step B, after the tris material 13 and the tris(hydroxymethyl)aminomethane hydrochloride 14 are placed into the wet mixer 500, a rotation speed of the wet mixer 500 is increased from the first rotation speed to a second rotation speed for grinding and stirring. That is, the second rotation speed is higher than the first rotation speed. In the step B, the second rotation speed of the wet mixer 500 is 2400 rpm±20%. A grinding and stirring time of the wet mixer 500 is 0.5 hour. An operation temperature of the wet mixer 500 is 20° C.±4° C.

The purpose of adding the tris(hydroxymethyl)aminomethane hydrochloride 14 is to control the pH value of the chemical reaction of the first LLZO particles 10 and the tris molecules. Because the chemical reaction of the first LLZO particles 10 and the tris molecules needs to be catalyzed under alkaline, however if the alkalinity is too high, it will also cause hydrolysis and deterioration of the first LLZO particles 10. Therefore, by adding the tris(hydroxymethyl)aminomethane hydrochloride 14, the pH value can be decreased to lower the alkalinity in the chemical reaction.

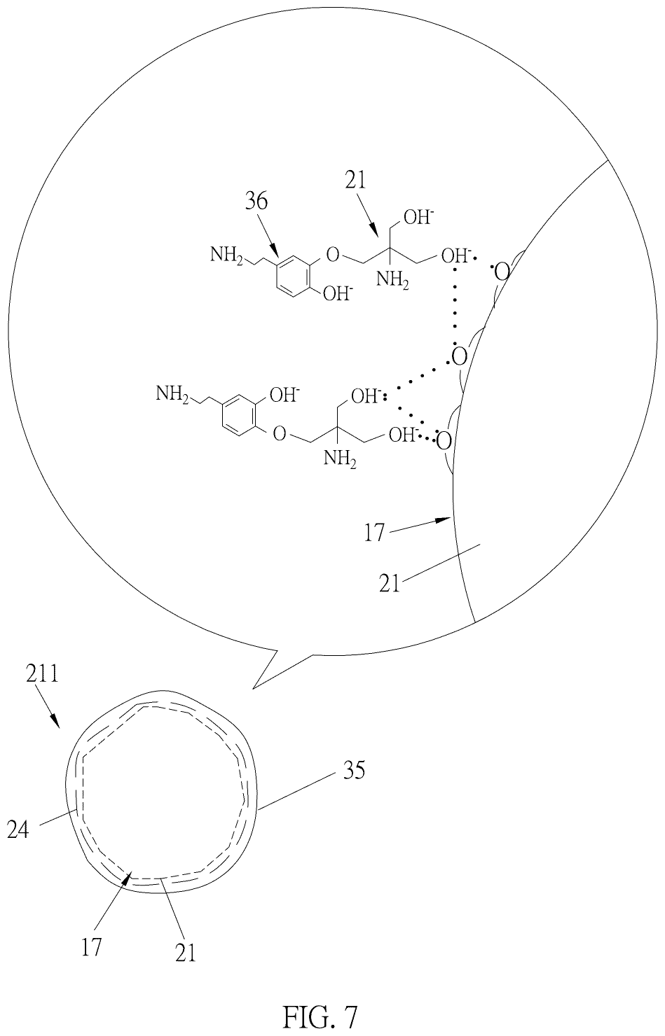

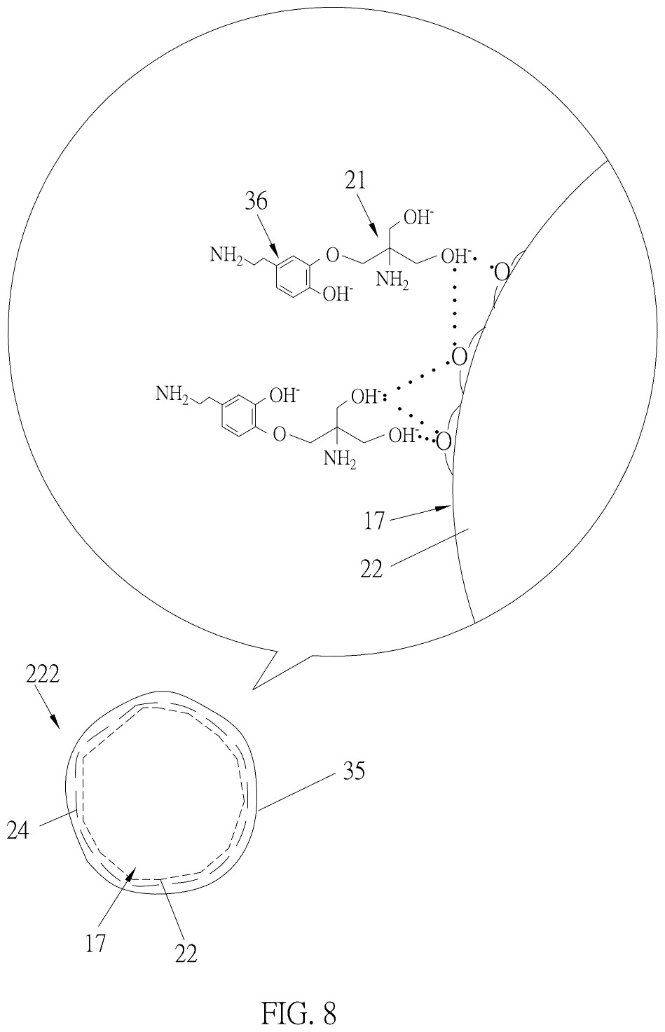

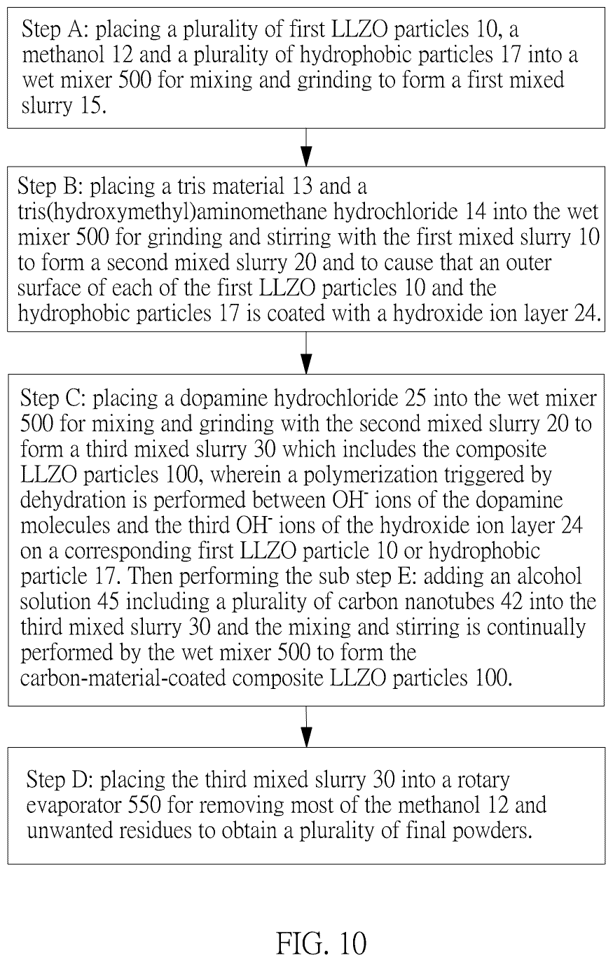

Step C: placing a dopamine hydrochloride ((HO)₂C₆H₃CH₂CH₂NH₂·HCl) 25 into the wet mixer 500 for mixing and grinding with the second mixed slurry 20 to form a third mixed slurry 30 which includes the composite LLZO particles 100. The dopamine hydrochloride 25 has a plurality of dopamine molecules. A polymerization triggered by dehydration is performed between OH ions of the dopamine molecules and the third OH-ions of the hydroxide ion layer 24 on a corresponding first LLZO particle 10 or hydrophobic particle 17, which causes that each of the first LLZO particles 10 and the hydrophobic particles 17 is bound to a plurality of corresponding dopamine molecules. The corresponding dopamine molecules are co-polymerized to form a dopamine layer 35 coated on an outer surface of the hydroxide ion layer 24 on the corresponding first LLZO particle 10 or hydrophobic particle 17 (as shown in FIGS. 6 to 8). The first LLZO particles 10 coated with the dopamine layer 35 form a plurality of hydrophobic LLZO particles 102. When the hydrophobic particle 17 is the barium titanate particle 21, the hydrophobic particle 17 coated with the dopamine layer 35 forms a hydrophobic barium titanate composite particle 212 (as shown in FIG. 7). When the hydrophobic particle 17 is the zinc oxide particle 22, the hydrophobic particle 17 coated with the dopamine layer 35 forms a hydrophobic zinc oxide composite particle 222 (as shown in FIG. 8). Each of the hydrophobic LLZO particles 102 is coated with a plurality of corresponding hydrophobic barium titanate composite particles 212 or hydrophobic zinc oxide composite particles 222 to form a corresponding composite LLZO particle 100 (as shown in FIG. 10). A thickness of the dopamine layer 35 is 1 nm˜10 nm.

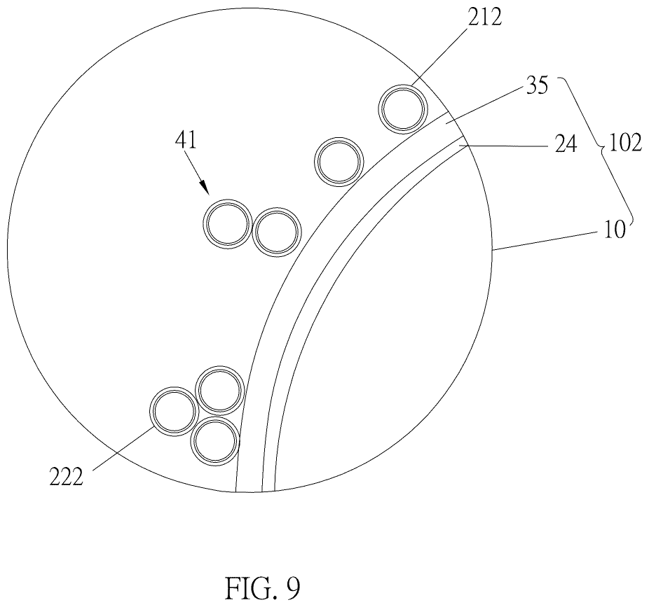

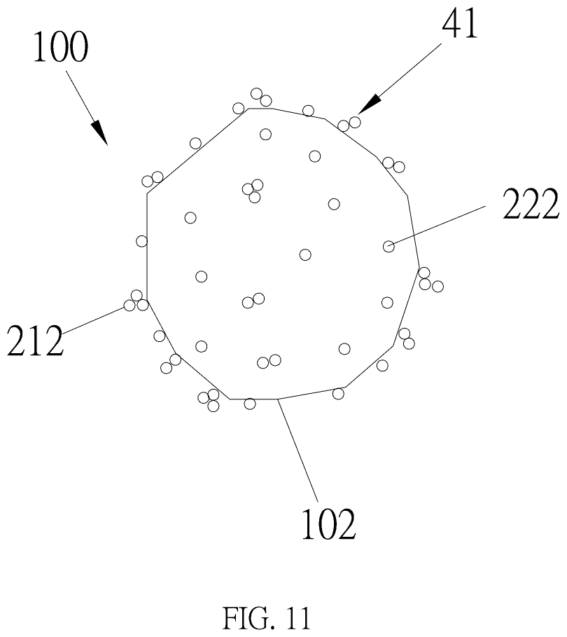

Referring to FIGS. 9, 11 and 13, the composite LLZO particles 100 is formed in the step C. Each of the composite LLZO particles 100 includes: the first LLZO particle 10 which is used to guide and disperse paths of lithium ions; an outer surface of the first LLZO particle 10 is coated with a corresponding hydroxide ion layer 24. An outer side of the hydroxide ion layer 24 on the first LLZO particle 10 is coated with a corresponding dopamine layer 35, which forms a corresponding hydrophobic LLZO particle 102 (as shown in FIG. 6). The dopamine molecules of the dopamine layer 35 are hydrophobic to protect the first LLZO particle 15 and to prevent the first LLZO particle 15 from being dampened. An outer surface of the hydrophobic LLZO particle 102 is coated with an outer hydrophobic layer 41, which forms the composite LLZO particles 100 (as shown in FIG. 11). The outer hydrophobic layer 41 is formed by a plurality of corresponding hydrophobic barium titanate composite particles 212, or is formed by a plurality of corresponding hydrophobic zinc oxide composite particles 222, or is formed by the corresponding hydrophobic barium titanate composite particles 212 and the hydrophobic zinc oxide composite particles 222.

An outer side of the barium titanate particle 21 of each of the hydrophobic barium titanate composite particles 212 and an outer side of the zinc oxide particle 22 of each of the hydrophobic zinc oxide composite particles 222 are respectively coated with a corresponding hydroxide ion layer 24. The hydroxide ion layer 24 on the barium titanate particle 21 and the hydroxide ion layer 24 on the zinc oxide particle 22 are respectively coated with a corresponding dopamine layer 35. The outer hydrophobic layer 41 is coated on the outer surface of the hydrophobic LLZO particle 102 by the chain co-polymerization of the dopamine molecules of the dopamine layer 35 of the hydrophobic LLZO particle 102 and the dopamine molecules of the dopamine layers 35 on the outer hydrophobic layer 41. The distribution of the hydrophobic barium titanate composite particles 212 and the hydrophobic zinc oxide composite particles 222 on the hydrophobic LLZO particle 102 is a naturally formed result in the stirring of the step C.

A ratio of the total weight of the first LLZO particles 10, a total weight of the tris material 13 and the tris(hydroxymethyl)aminomethane hydrochloride 14 and a weight of the dopamine hydrochloride 25 is 1:0.8˜1:2.2˜2.4.

In the step C, the rotation speed of the wet mixer 500 is decreased from the second rotation speed to a third rotation speed. That is, the third rotation speed is lower than the second rotation speed. In the step C, the third rotation speed of the wet mixer 500 is 2000 rpm±20%. A mixing and grinding time of the wet mixer 500 is 0.5 to 1 hour. An operation temperature of the wet mixer 500 is 20° C.±4° C.

Since moisture exists during the manufacturing process of the electrode, and the LLZO particles are hydrophilic and is easy to be dampened to form an alkali. Therefore, in the present invention, an outer side of the first LLZO particle 15 is coated with a protective layer (the dopamine layer 35) to prevent the first LLZO particle 10 from being dampened during the manufacturing process of the electrode. Because the dopamine molecules are hydrophobic, the dopamine hydrochloride 25 is added in the step C, which causes the dopamine molecules to form the dopamine layer 35 to be coated on the first LLZO particle 10 and prevent the first LLZO particle 10 from being dampened by water.

Step D: placing the third mixed slurry 30 having the composite LLZO particles 100 formed in the step C into a rotary evaporator 550 for removing most of the methanol 12 and unwanted residues, and performing a drying by the rotary evaporator 550 for evaporating the solvents including the methanol 12 and hydrochloric acid in the third mixed slurry 30 to obtain a plurality of final powders.

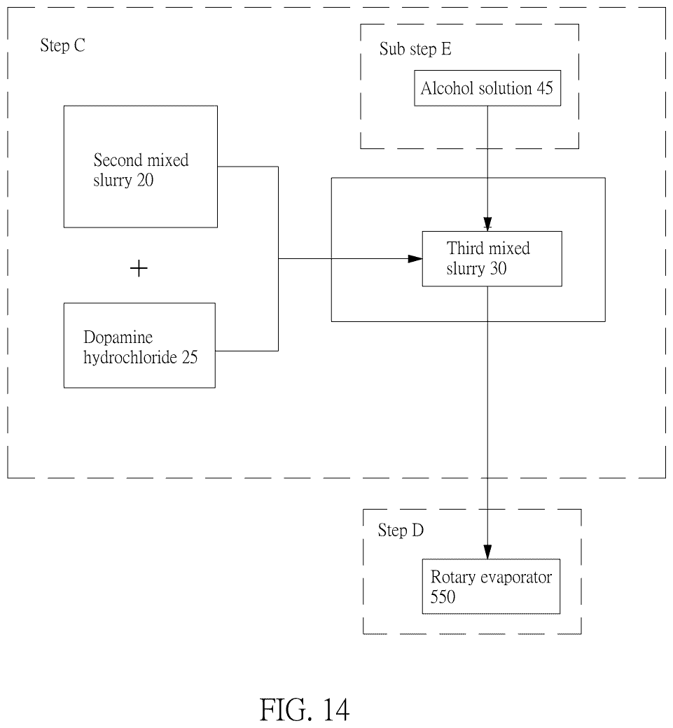

Referring to FIGS. 10 and 14, the step C further includes the following sub step E:

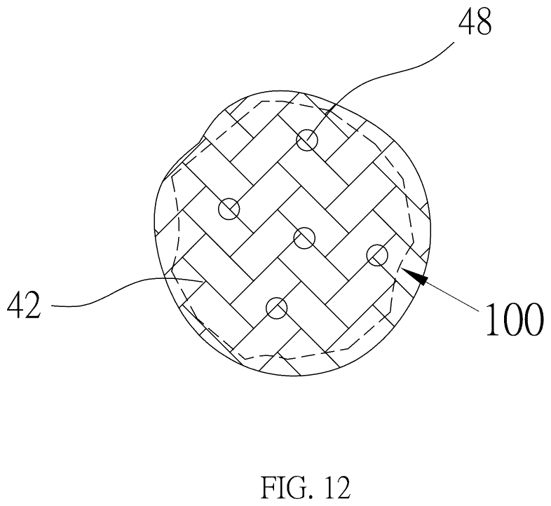

Sub step E: after forming the third mixed slurry 30 by the wet mixer 500, an alcohol solution 45 including a plurality of carbon nanotubes 42 is further added into the third mixed slurry 30 and the mixing and stirring is continually performed by the wet mixer 500 to cause that an outer surface of each of the composite LLZO particles 100 is wrapped by a plurality of corresponding carbon nanotubes 42 to form the carbon-material-coated composite LLZO particles 100. Each of the carbon-material-coated composite LLZO particles 100 has a hairball-like structure (as shown in FIG. 12). Preferably, the alcohol solution 45 is a methanol solution.

In the sub step E of the step C, after adding the alcohol solution 45 into the wet mixer 500, the wet mixer 500 continually performs the mixing and stirring for 0.5 hour at a rotation speed of 2000 rpm±20% under an operation temperature of 20° C.±4° C.

A size of each of the carbon nanotubes 42 is 0.5 μm to 3 μm. A ratio of a weight of the alcohol solution 45 and a weight of the third mixed slurry 30 is 0.01˜0.5:100.

After the step D, a size of each of the composite LLZO particles 100 is 50 nm to 200 nm. Each of the composite LLZO particles 100 is a cube having an irregular three-dimensional shape.

The carbon nanotubes 42 serve to increase the electrical conductivity by forming a plurality of conductive bridges around various composite LLZO particles 100 for conducting the electron on the composite LLZO particles 100. The carbon nanotubes 42 have an extremely high electrical conductivity, so that lithium ions can pass through the carbon nanotubes 42 and conduct between the composite LLZO particles 100, which increase the electrical conductivity of the entire electrode.

The alcohol solution 45 further includes a plurality of nanoscale amorphous carbons 48. A size of each of nanoscale amorphous carbons 48 is 10 nm to 40 nm. Preferably, the nanoscale amorphous carbons 48 are amorphous carbons of a Super P auxiliary agent. The carbon nanotubes 42 and the nanoscale amorphous carbons 48 are used as an auxiliary agent. The nanoscale amorphous carbons 48 are in a form of particles and the carbon nanotubes 42 are in a form of long strips. The nanoscale amorphous carbons 45 are filled in a plurality of gaps formed by a interleaving structure formed by the carbon nanotubes 42 on the composite LLZO particles 100, which can transmit the electric charge between the carbon nanotubes 42 through the spanning of the nanoscale amorphous carbons 35, resulting in increasing the transmitting efficiency of the electric current.

The advantages of the present invention are that multiple mixing stages are used in the present invention to replace the conventional single mixing stage. Therefore, in the present invention, the mixing process is divided into multiple stages to extend the whole reaction time, which can make the LLZO particles have a smaller size and a larger surface area to effectively and fully react with the tris and dopamine hydrochloride. As a result, the surface of the LLZO particle can be completely coated with a solid dopamine layer. The outer surface of the LLZO particle having the dopamine layer is further coated with hydrophobic barium titanate composite particles and hydrophobic zinc oxide composite particles, resulting forming a better hydrophobic protective structure. As a result, the composite LLZO particle of the present invention has an enhanced lithium conductivity and no reaction will be formed between the water and the LLZO particles in the manufacturing process of electrodes, which achieves a better manufacturing quality of the battery electrode material.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing composite ceramic electrolyte particles with hydrophobic protective layers for a battery electrode; the composite ceramic electrolyte particles being a plurality of composite LLZO particles; the method comprising the steps of:
step A: placing a plurality of first LLZO particles, a methanol and a plurality of hydrophobic particles into a wet mixer for mixing and grinding at a first rotation speed to form a first mixed slurry; wherein the hydrophobic particles are a plurality of barium titanate particles, or are a plurality of zinc oxide particles, or are the barium titanate particles and the zinc oxide particles; each of the hydrophobic particles is selected from one of the barium titanate particle and the zinc oxide particle; and the wet mixer has a plurality of zirconium balls for mixing and grinding to cause that the size of each of the first LLZO particles is smaller than 500 nm after the mixing and grinding;
step B: placing a tris (tris(hydroxymethyl)aminomethane, (HOCH₂)₃CNH₂) material and a tris(hydroxymethyl)aminomethane hydrochloride (NH₂C(CH₂OH)₃·HCl) into the wet mixer for grinding and stirring with the first mixed slurry to form a second mixed slurry and to cause that an outer surface of each of the first LLZO particles and the hydrophobic particles is coated with a hydroxide ion layer; wherein the hydroxide ion layer has a plurality of third OH⁻ ions; each of tris molecules in the tris material and the tris(hydroxymethyl)aminomethane hydrochloride has three OH⁻ ions which are a first OH⁻ ion, a second OH⁻ ion and the third OH⁻ ion; the first OH⁻ ions and the second OH⁻ ions of the tris molecules are bound to the oxidizing functional groups on a corresponding first LLZO particle or hydrophobic particle by hydrogen bonding; the third OH⁻ ions of the tris molecules extend outward to an outer side of the corresponding first LLZO particle or hydrophobic particle to form the hydroxide ion layer on the corresponding first LLZO particle or hydrophobic particle;
wherein in the step B, after the tris material and the tris(hydroxymethyl)aminomethane hydrochloride are placed into the wet mixer, a rotation speed of the wet mixer is increased from the first rotation speed to a second rotation speed for grinding and stirring;
step C: placing a dopamine hydrochloride ((HO)₂C₆H₃CH₂CH₂NH₂·HCl) into the wet mixer for mixing and grinding with the second mixed slurry to form a third mixed slurry which includes the composite LLZO particles; wherein the dopamine hydrochloride has a plurality of dopamine molecules; a polymerization triggered by dehydration is performed between OH ions of the dopamine molecules and the third OH⁻ ions of the hydroxide ion layer on a corresponding first LLZO particle or hydrophobic particle, which causes that each of the first LLZO particles and the hydrophobic particles is bound to a plurality of corresponding dopamine molecules; the corresponding dopamine molecules are co-polymerized to form a dopamine layer coated on an outer surface of the hydroxide ion layer on the corresponding first LLZO particle or hydrophobic particle; the first LLZO particles coated with the dopamine layer form a plurality of hydrophobic LLZO particles; when the hydrophobic particle is the barium titanate particle, the hydrophobic particle coated with the dopamine layer forms a hydrophobic barium titanate composite particle; when the hydrophobic particle is the zinc oxide particle, the hydrophobic particle coated with the dopamine layer forms a hydrophobic zinc oxide composite particle; and each of the hydrophobic LLZO particles is coated with a plurality of corresponding hydrophobic barium titanate composite particles or hydrophobic zinc oxide composite particles to form a corresponding composite LLZO particle;
wherein in the step C, the rotation speed of the wet mixer is decreased from the second rotation speed to a third rotation speed;
wherein each of the composite LLZO particles includes the first LLZO particle which is used to guide and disperse paths of lithium ions; an outer surface of the first LLZO particle is coated with a corresponding hydroxide ion layer; an outer side of the hydroxide ion layer on the first LLZO particle is coated with a corresponding dopamine layer, which forms a corresponding hydrophobic LLZO particle; the dopamine molecules of the dopamine layer are hydrophobic to protect the first LLZO particle and to prevent the first LLZO particle from being dampened; an outer surface of the hydrophobic LLZO particle is coated with an outer hydrophobic layer, which forms the composite LLZO particles; and the outer hydrophobic layer is formed by a plurality of corresponding hydrophobic barium titanate composite particles, or is formed by a plurality of corresponding hydrophobic zinc oxide composite particles, or is formed by the corresponding hydrophobic barium titanate composite particles and the hydrophobic zinc oxide composite particles; and
wherein an outer side of the barium titanate particle of each of the hydrophobic barium titanate composite particles and an outer side of the zinc oxide particle of each of the hydrophobic zinc oxide composite particles are respectively coated with a corresponding hydroxide ion layer; the hydroxide ion layer on the barium titanate particle and the hydroxide ion layer on the zinc oxide particle are respectively coated with a corresponding dopamine layer; and the outer hydrophobic layer is coated on the outer surface of the hydrophobic LLZO particle by chain co-polymerization of the dopamine molecules of the dopamine layer of the hydrophobic LLZO particle and the dopamine molecules of the dopamine layers on the outer hydrophobic layer.

2. The method for manufacturing the composite ceramic electrolyte particles with the hydrophobic protective layers for the battery electrode as claimed in claim 1, further comprising the steps of:
step D: placing the third mixed slurry having the composite LLZO particles formed in the step C into a rotary evaporator for removing most of the methanol and unwanted residues, and performing a drying by the rotary evaporator for evaporating the solvents including the methanol and hydrochloric acid in the third mixed slurry to obtain a plurality of final powders.

3. The method for manufacturing the composite ceramic electrolyte particles with the hydrophobic protective layers for the battery electrode as claimed in claim 1, wherein in the step C, after forming the third mixed slurry by the wet mixer, an alcohol solution including a plurality of carbon nanotubes is further added into the third mixed slurry and the mixing and stirring is continually performed by the wet mixer to cause that an outer surface of each of the composite LLZO particles is wrapped by a plurality of corresponding carbon nanotubes to form the carbon-material-coated composite LLZO particles.

4. The method for manufacturing the composite ceramic electrolyte particles with the hydrophobic protective layers for the battery electrode as claimed in claim 3, wherein the alcohol solution further includes a plurality of nanoscale amorphous carbons; a size of each of nanoscale amorphous carbons is 10 nm to 40 nm; and the nanoscale amorphous carbons are filled in a plurality of gaps formed by a interleaving structure formed by the carbon nanotubes on the composite LLZO particles.

5. The method for manufacturing the composite ceramic electrolyte particles with the hydrophobic protective layers for the battery electrode as claimed in claim 3, wherein a size of each of the carbon nanotubes is 0.5 μm to 3 μm.

6. The method for manufacturing the composite ceramic electrolyte particles with the hydrophobic protective layers for the battery electrode as claimed in claim 3, wherein in the step A, a ratio of a total weight of the first LLZO particles and a weight of the methanol is 0.8˜1.2:4; a ratio of a total weight of the hydrophobic particles and the total weight of the first LLZO particles is 1/25˜ 1/10; and
wherein in the step C, a ratio of a weight of the alcohol solution and a weight of the third mixed slurry is 0.01˜0.5:100.

7. The method for manufacturing the composite ceramic electrolyte particles with the hydrophobic protective layers for the battery electrode as claimed in claim 1, wherein the composite LLZO particles is used in an electrode of a solid-state or semi-solid battery.

8. The method for manufacturing the composite ceramic electrolyte particles with the hydrophobic protective layers for the battery electrode as claimed in claim 1, wherein each of the first LLZO particles is formed by LLZO (lithium lanthanum zirconium oxide, Li₇La₃Zr₂O₁₂) or LLZO doped with at least one metal.

9. The method for manufacturing the composite ceramic electrolyte particles with the hydrophobic protective layers for the battery electrode as claimed in claim 2, wherein after the step D, a size of each of the composite LLZO particles is 50 nm to 200 nm and each of the first LLZO particles is a cube having an irregular three-dimensional shape.

10. The method for manufacturing the composite ceramic electrolyte particles with the hydrophobic protective layers for the battery electrode as claimed in claim 1, wherein in the step B, a ratio of a weight of the tris material and a weight of the tris(hydroxymethyl)aminomethane hydrochloride is 8:2; and
wherein in the step C, a ratio of a total weight of the first LLZO particles, a total weight of the tris material and the tris(hydroxymethyl)aminomethane hydrochloride and a weight of the dopamine hydrochloride is 1:0.8˜1:2.2˜2.4.

11. The method for manufacturing the composite ceramic electrolyte particles with the hydrophobic protective layers for the battery electrode as claimed in claim 1, wherein in the step C, a thickness of the dopamine layer is 1 nm˜10 nm.

12. The method for manufacturing the composite ceramic electrolyte particles with the hydrophobic protective layers for the battery electrode as claimed in claim 1, wherein in the step A, the first rotation speed of the wet mixer is 2200 rpm±20%; each of the first zirconium balls has a grain size of 0.7 mm to 0.9 mm; a filling ratio of a total volume of the zirconium balls is 70% to 90%, which is a ratio of the total volume of the zirconium balls to a grinding volume of the wet mixer; a mixing and grinding time of the wet mixer is 1 to 1.5 hours; an operation temperature of the wet mixer is 20° C.±4° C.;
wherein in the step B, the second rotation speed of the wet mixer is 2400 rpm±20%; a grinding and stirring time of the wet mixer is 0.5 hour; and the operation temperature of the wet mixer is 20° C.±4° C.; and
wherein in the step C, the third rotation speed of the wet mixer is 2000 rpm±20%; a mixing and grinding time of the wet mixer is 0.5 to 1 hour; and the operation temperature of the wet mixer is 20° C.±4° C.

13. The method for manufacturing the composite ceramic electrolyte particles with the hydrophobic protective layers for the battery electrode as claimed in claim 3, wherein in the step C, after adding the alcohol solution into the wet mixer, the wet mixer continually performs the mixing and stirring for 0.5 hour at a rotation speed of 2000 rpm±20% under an operation temperature of 20° C.±4° C.

14. The method for manufacturing the composite ceramic electrolyte particles with the hydrophobic protective layers for the battery electrode as claimed in claim 2, wherein in the step C, after forming the third mixed slurry by the wet mixer, an alcohol solution including a plurality of carbon nanotubes is further added into the third mixed slurry and the mixing and stirring is continually performed by the wet mixer to cause that an outer surface of each of the composite LLZO particles is wrapped by a plurality of corresponding carbon nanotubes to form the carbon-material-coated composite LLZO particles.

15. The method for manufacturing the composite ceramic electrolyte particles with the hydrophobic protective layers for the battery electrode as claimed in claim 14, wherein the alcohol solution further includes a plurality of nanoscale amorphous carbons; a size of each of nanoscale amorphous carbons is 10 nm to 40 nm; and the nanoscale amorphous carbons are filled in a plurality of gaps formed by a interleaving structure formed by the carbon nanotubes on the composite LLZO particles.

16. The method for manufacturing the composite ceramic electrolyte particles with the hydrophobic protective layers for the battery electrode as claimed in claim 14, wherein a size of each of the carbon nanotubes is 0.5 μm to 3 μm.

17. The method for manufacturing the composite ceramic electrolyte particles with the hydrophobic protective layers for the battery electrode as claimed in claim 14, wherein in the step A, a ratio of a total weight of the first LLZO particles and a weight of the methanol is 0.8˜1.2:4; a ratio of a total weight of the hydrophobic particles and the total weight of the first LLZO particles is 1/25˜ 1/10; and
wherein in the step C, a ratio of a weight of the alcohol solution and a weight of the third mixed slurry is 0.01˜0.5:100.

18. The method for manufacturing the composite ceramic electrolyte particles with the hydrophobic protective layers for the battery electrode as claimed in claim 14, wherein in the step C, after adding the alcohol solution into the wet mixer, the wet mixer continually performs the mixing and stirring for 0.5 hour at a rotation speed of 2000 rpm±20% under an operation temperature of 20° C.±4° C.
